(19) United States
(12) Patent Application Publication
(10) Pub. No.: US 2008/0156881 A1
(43) Pub. Date: Jul. 3, 2008

(54) Illumination system including a curved mirror for an imaging-based bar code reader

(75) Inventor: Igor Vinogradov, New York, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: SYMBOL TECHNOLOGIES, INC., Holtsville, NY (US)

(21) Appl. No.: 11/647,891

(22) Filed: Dec. 29, 2006

(51) Int. Cl. G06K 7/10

(52) U.S. Cl. 235/462.42

(57) ABSTRACT

A method and apparatus for illuminating a target object such as a bar code having areas of differing light reflectivity on the target. A bar code reader has a light source that is selectively activated and a reflecting mirror for reflecting light from the source from a housing to a target object within a field of view of an imaging capturing device. One suitable mirror is a parabolic mirror having a focal point approximately at the location of the light source.

### FIELD OF THE INVENTION

The present invention relates to an illumination system for an imaging-based bar code reader and, more particularly, to an illumination system including a curved illumination mirror.

### BACKGROUND ART

Various electro-optical systems have been developed for reading optical indicia, such as bar codes. A bar code is a coded pattern of graphical indicia comprised of a series of bars and spaces of varying widths, the bars and spaces having differing light reflecting characteristics. Some of the more popular bar code symbologies include: Uniform Product Code (UPC), typically used in retail stores sales; Code 39, primarily used in inventory tracking; and Postnet, which is used for encoding zip codes for U.S. mail. Systems that read and decode bar codes employing charged coupled device (CCD) or complementary metal oxide semiconductor (CMOS) based imaging systems are typically referred to hereinafter as imagining systems, imaging-based bar code readers or bar code scanners.

Bar code readers electro-optically transform the graphic indicia of the bar code into electrical signals, which are decoded into alphanumerical characters that are intended to be descriptive of the article containing the bar code. The characters are then typically represented in digital form and utilized as an input to a data processing system for various end-user applications such as point-of-sale processing, inventory control and the like.

Imaging systems used in bar code scanners include charge coupled device (CCD) arrays, complementary metal oxide semiconductor (CMOS) arrays, or other imaging pixel arrays having a plurality of photosensitive elements (photosensors) or pixel array. An illumination system comprising light emitting diodes (LEDs) or other light source directs illumination toward a target object, e.g., a target bar code. Light reflected from the target bar code is focused through a lens of the imaging system onto the pixel array. Thus, an image of an object within the field of view (FOV) of the focusing lens is focused on the pixel array. Periodically, the pixels of the array are sequentially read out generating an analog signal representative of a captured image frame. The analog signal is amplified by a gain factor and the amplified analog signal is digitized by an analog-to-digital converter. Decoding circuitry of the imaging system processes the digitized signals representative of the captured image frame and attempts to decode the imaged bar code.

As mentioned, imaging-based bar code readers typically employ an illumination system to flood a target object with illumination from a light source such as a light emitting diode (LED) in the reader. Light from the light source or LED is reflected from the target object. The reflected light is then focused through a lens of the imaging system onto the pixel array, the target object being within a field of view of the lens.

Usually, an imaging scanner has an illumination system that enables reading barcodes under low light conditions. It is also desirable to direct the light from the light source efficiently toward only the barcode. In some cases when a barcode is located on a shiny reflective surface such as surgical instruments or displays of cell phones, it is necessary to have a large area illumination system. The imaging camera of the reader captures the image of the barcode with the illumination system reflected on the background from the shiny surface of the object on which the barcode appears. The light from the barcode itself is scattered or absorbed and appears as dark features in an image. The light image is created due to the imaging system being reflected off of shiny barcode supporting surface.

It is known in the prior art to use a white diffusive surface illuminated by multiple LED sources or a combination of clusters of multiple LEDs. The light from the light source (LEDs) is directed to the back or the front of the white surface and the surface scatters light in all directions including in the direction of the bar code for reflection back to the scanner imaging camera. These designs that use a secondary source of light to illuminate the barcode are both expensive and inefficient. This type of system is very inefficient since the light gets scattered in all directions and only a small portion of light from the diffusive surface reaches the barcode.

### SUMMARY

The present disclosure is directed to an imaging-based bar code reading having an illumination system for generating an illumination pattern.

In the present invention a curved (preferably parabolic) illumination mirror is used to illuminate the barcode. Light from a source strikes the parabolic mirror and does not significantly diverge so it efficiently illuminates the bar code. The parabolic mirror may encompass a large area, and this makes it easier to capture the image of the illumination source reflected from the bar code by an imaging camera.

In this system light from the mirror reflected to the barcode is collimated and directed toward the object and is not as diffuse as light reflecting off from a scattering surface such as a white screen. Light from a single LED may be sufficient to illuminate the bar code (or target object).

In one exemplary embodiment, a bar code scanner has a scanner housing which supports image analysis circuitry within a housing interior for capturing a bar code image. An exemplary illumination assembly emits illumination light from the housing interior to a bar code target object spaced from the housing. The illumination system includes an illumination source that, when energized emits light passing through a region of the scanner housing and a mirror having a curved surface positioned within the housing to reflect light from the illumination source to a region of interest outside the housing for imaging a bar code (or target object).

In one embodiment, a concave surface of the mirror approximates a section of a parabola and the source of light is located in a close proximity of the focal point. This arrangement produces nearly collimated light bouncing off from the mirror. The diverging angle of the outgoing light can be optimized in such a way to match the field of view of the imaging lens by this means providing sufficient illumination level over the entire FOV.

These and other objects, advantages, and features of the exemplary embodiments are described in detail in conjunction with the accompanying drawings.

### BRIEF DESCRIPTION OF THE DRAWINGS

FIG. 1 is a schematic side elevation view of an exemplary embodiment of an imaging-based bar code reader of the present invention;

FIG. 2 is a schematic front elevation view of the bar code reader of FIG. 1;

FIG. 3 is a schematic block diagram of the bar code reader of FIG. 1; and

FIG. 4 is a schematic view an imaging assembly of the bar code reader of FIG. 1.

### DETAILED DESCRIPTION

An exemplary embodiment of an imaging-based bar code reader of the present invention is shown schematically at 10 in the Figures. The bar code reader 10 includes a two dimensional (2D) imaging system 12 and a decoding system 14 supported in a housing 16. The imaging and decoding systems 12, 14 are capable of reading, that is, imaging and decoding both 1D and 2D bar codes and postal codes. The reader 10 is also capable of capturing images and signatures.

The decoding system 14 is adapted to decode encoded indicia within a selected captured image frame. The housing 16 supports reader circuitry 11 within an interior region 17 of the housing 16. The reader circuitry 11 includes a microprocessor 11a and a power supply 11b. The power supply 11b is electrically coupled to and provides power to the circuitry 11. The housing 16 also supports the imaging and decoding systems 12, 14 within the housing's interior region 17. The depicted reader 10 includes a docking station 30 adapted to receive the housing 16. The docking station 30 and the housing 16 support an electrical interface to allow electric coupling between circuitry resident in the housing 16 and circuitry resident in the docking station 30.

The imaging and decoding systems 12, 14 operate under the control of the microprocessor 11a. The imaging and decoding systems 12, 14 may be separate assemblies which are electrically coupled or may be integrated into a single imaging and decoding system. When removed from the docking station 30 of the reader 10, power is supplied to the imaging and decoding systems 12, 14 by the power supply 11b. The circuitry of the imaging and decoding systems 12, 14 may be embodied in hardware, software, firmware or electrical circuitry or any combination thereof. Moreover, portions of the circuitry 11 may be resident in the housing 16 or the docking station 30.

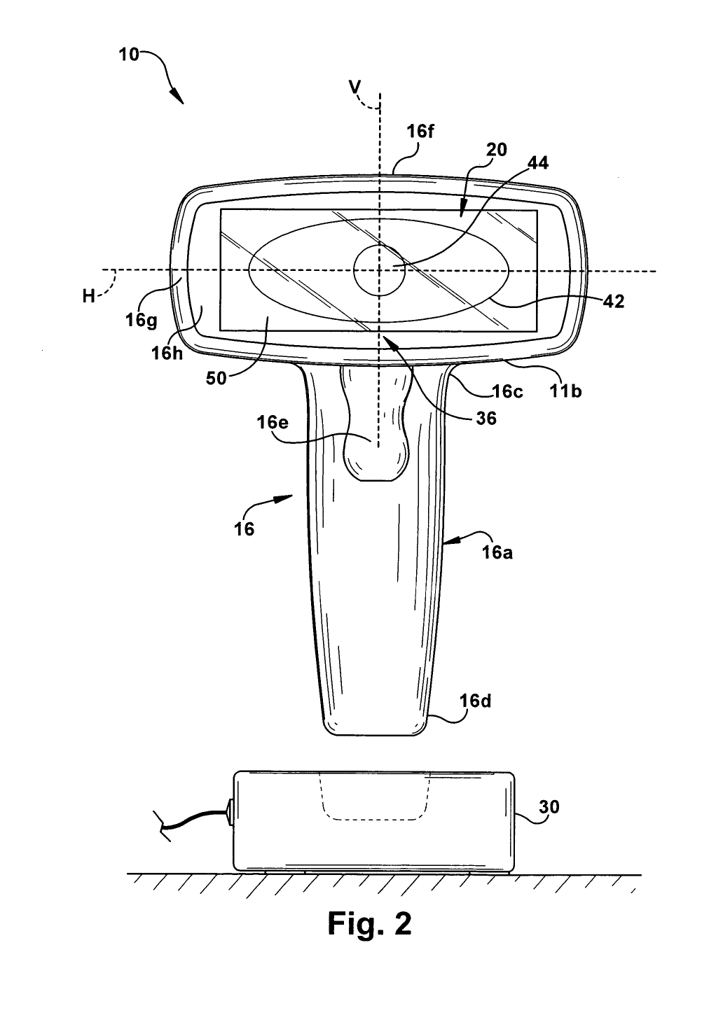

Advantageously, the bar code reader 10 of the present invention is adapted to be used in two modes of operation. In a hand-held or point-and-shoot mode of operation (FIG. 2), the reader 10 is carried and operated by a user walking or riding through a store, warehouse or plant for reading target bar codes for stocking and inventory control purposes. In the hand-held mode, the housing 16 is removed from a docking station 30 so the reader 10 can be carried by the user. The user grasps the housing gripping portion 16a and positions the housing 16 with respect to the target bar code 34 such that the target bar code is within a field of view of the imaging system 12.

In the hand-held mode, imaging and decoding of the target bar code 34 is instituted by the user depressing a trigger switch16e which extends through an opening near the upper part 16c of the gripping portion 16a. When the trigger 16e is depressed, the imaging system 12 generates a series of image frames (54a-54f for example) until either the user releases the trigger 16e, the image 34′ of one frame (54d for example) the target bar code 34 has been successfully decoded or a predetermined period of time elapses, whereupon the imaging system 12 awaits a new trigger signal.

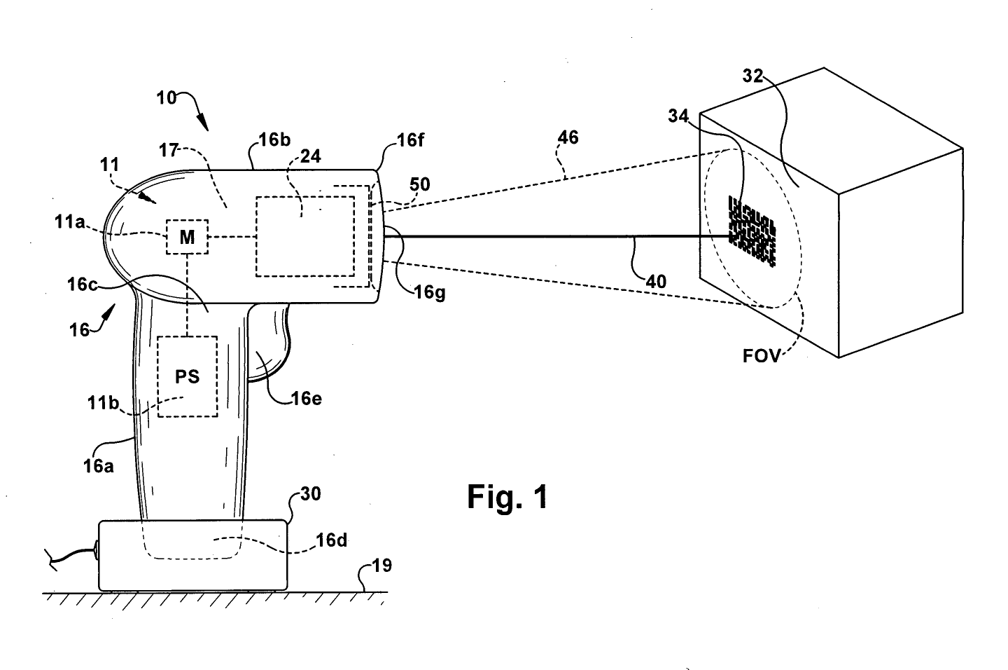

In a fixed position or hands-free mode (FIG. 1), the reader 10 is received in the docking station 30 which is positioned on a substrate, such as a table or counter 19. The docking station 30 includes a generally planar lower surface to provide stability to the reader 10 when positioned on the substrate 19. In the fixed position mode, an object or item 32 with a target bar code 34 imprinted or affixed to it are brought to the reader 10 and positioned such that the target bar code 34 is within a field of view of the reader imaging system 12 for reading the target bar code 34. Typically, the imaging system 12 is always on or operational in the fixed position mode to image and decode any target bar code presented to the reader 10 within the field of view.

The docking station 30 is plugged into an AC power source and provides regulated DC power to the circuitry 11 of the reader 10. Thus, when the reader 10 is in the docking station 30 power is available to keep the imaging system 12 on continuously. In the fixed position mode, the imaging system 12 produces a continuous, sequential series of image frames 54 of the field of view.

The bar code reader 10 includes an illumination system 36 to illuminate the target bar code 34. The illumination system 36 typically includes one or more illumination LEDs 38 which are energized to direct illumination light to a reflecting mirror 42 which reflects light to the bar code. A center line 40 of the illumination zone of the illumination system 36 can be moved from side to side and up and down as the user manipulates the scanner.

An aiming system 38 (not shown) may optionally be used to generate a visible aiming pattern comprising a single dot of illumination, a plurality of dots and/or lines of illumination or overlapping groups of dots/lines of illumination. If used, the aiming system may be intermittently energized in a flash mode such that at least some of the captured image frames 54a-54f do not include an image of the aiming pattern. The image of the aiming pattern 40 in an image frame may distort the imaged bar code 34′ and complicate the decoding of the imaged bar code.

The imaging system 12 comprises an imaging camera assembly 20 and associated imaging circuitry 22. The imaging camera 20 includes a housing 24 supporting focusing optics including a focusing lens 26 and a 2D sensor or pixel array 28. The sensor array 28 is enabled during an exposure period to capture an image of the field of view FV of the imaging system 12. The field of view FV of the imaging system 12 is a function of both the configuration of the sensor array 28 and the optical characteristics of the focusing lens 26 and the distance and orientation between the array 28 and the lens 26.

The camera housing 24 is positioned within an interior region 17 of the scanning head 16b. The housing 24 is in proximity to a transparent window 50 defining a portion of a front wall 16h of the housing scanning head 16b. Reflected light from the target bar code 34 passes through the transparent window 50, is received by the focusing lens 26 and focused onto the imaging system sensor array 28.

In an exemplary embodiment, the illumination assembly 36 of the LED 38 and the Mirror 42are positioned behind the window 50. Illumination from the illumination LED 38 and an aiming pattern also pass through the window 50.

The imaging system 12 includes the sensor array 28 of the imaging camera assembly 20. The sensor array 28 comprises a charged coupled device (CCD), a complementary metal oxide semiconductor (CMOS), or other imaging pixel array, operating under the control of the imaging circuitry 22. In one exemplary embodiment, the sensor array 28 comprises a two dimensional (2D) mega pixel CMOS array with a typical size of the pixel array being on the order of 1280×1024 pixels.

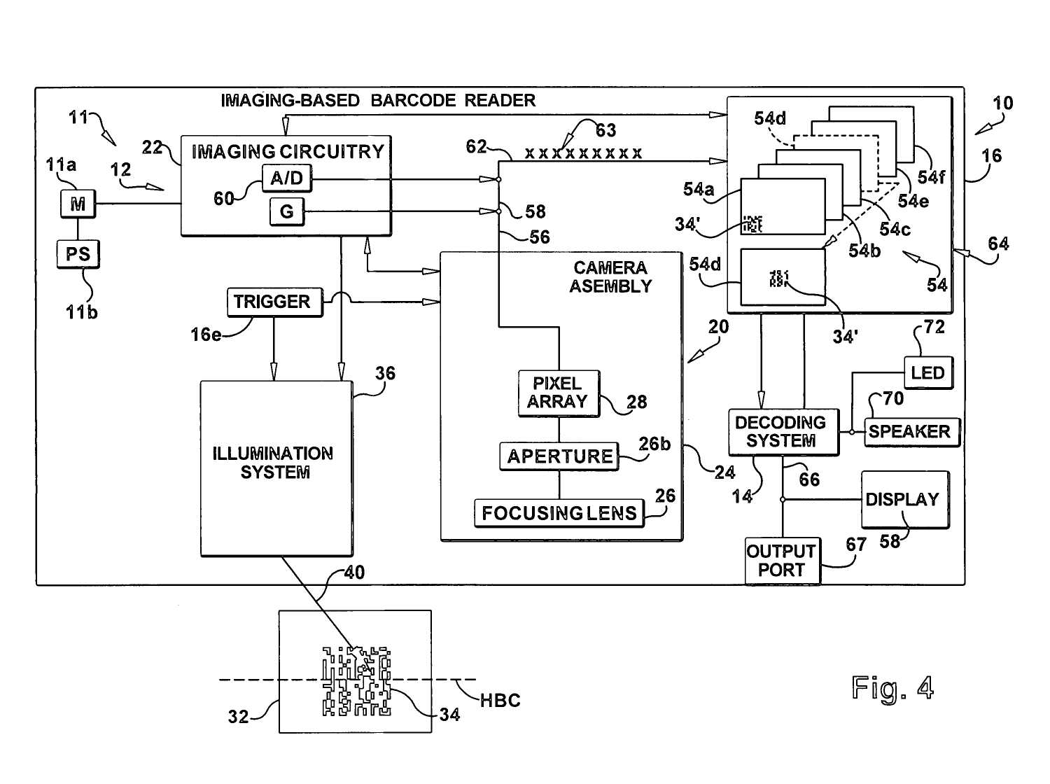

In the hand-held mode of operation, (possibly aided by the aiming system), the user points the housing 16 at the target bar code 34 and, assuming the target bar code 34 is within the field of view FV of the imaging assembly 12, each image frame 54a, 54b, 54c, . . . of the series of image frames 54 includes an image 34′ of the target bar code 34 (shown schematically in FIG. 4). The decoding system 14 selects an image frame from the series of image frames 54 and attempts to locate and decode a digitized version of the image bar code 34′.

The image frame selected for decoding by the decoding system 14 is typically an image frame captured when the aiming system 38 is turned off, otherwise, the aiming pattern 40 projected onto the target bar code 34 may distort the resulting imaged bar code 34′. In the fixed position mode of operation, the imaging system 12 is continuously generating a series of image frames 54. Since most of these captured frames 54 will not include an imaged bar code, the decoding system must analyze the series of image frames to find a subset of the series of image frames 54 (say 54a-54d in FIG. 5) that include the imaged bar code 34′. One of this image frame subset 54a-54d, one of the captured image frames 54d is selected for decoding.

Electrical signals are generated by reading out some or all of the pixels of the pixel array 28 after an exposure period generating an analog signal 56 (FIG. 4). In some sensors, particularly CMOS sensors, all pixels of the pixel array 28 are not exposed at the same time, thus, reading out of some pixels may coincide in time with an exposure period for some other pixels.

The analog image signal 56 represents a sequence of photosensor voltage values, the magnitude of each value representing an intensity of the reflected light received by a photosensor/pixel during an exposure period. The analog signal 46 is amplified by a gain factor, generating an amplified analog signal 58. The imaging circuitry 22 further includes an analog-to-digital (A/D) converter 60. The amplified analog signal 58 is digitized by the A/D converter 60 generating a digitized signal 62. The digitized signal 62 comprises a sequence of digital gray scale values 63 typically ranging from 0-255 (for an eight bit A/D converter, i.e., 2⁸=256), where a 0 gray scale value would represent an absence of any reflected light received by a pixel during an exposure or integration period (characterized as low pixel brightness) and a 255 gray scale value would represent a very intense level of reflected light received by a pixel during an exposure period (characterized as high pixel brightness).

The digitized gray scale values 63 of the digitized signal 62 are stored in a memory 64. The digital values 63 corresponding to a read out of the pixel array 28 constitute the image frame 54, which is representative of the image projected by the focusing lens 26 onto the pixel array 28 during an exposure period. If the field of view FV of the focusing lens 26 includes the target bar code 34, then a digital gray scale value image 14′ of the target bar code 14 would be present in the image frame 54.

The decoding circuitry 14 then operates on the digitized gray scale values 63 of the image frame 54 and attempts to decode any decodable image within the image frame, e.g., the imaged target bar code 14′. If the decoding is successful, decoded data 66, representative of the data/information coded in the bar code 34 is then output via a data output port 67 and/or displayed to a user of the reader 10 via a display 68. Upon achieving a good “read” of the bar code 34, that is, the bar code 34 was successfully imaged and decoded, a speaker 70 and/or an indicator LED 72 is activated by the bar code reader circuitry 13 to indicate to the user that the target bar code 14 has successfully read, that is, the target bar code 14 has been successfully imaged and the imaged bar code 14′ has been successfully decoded.

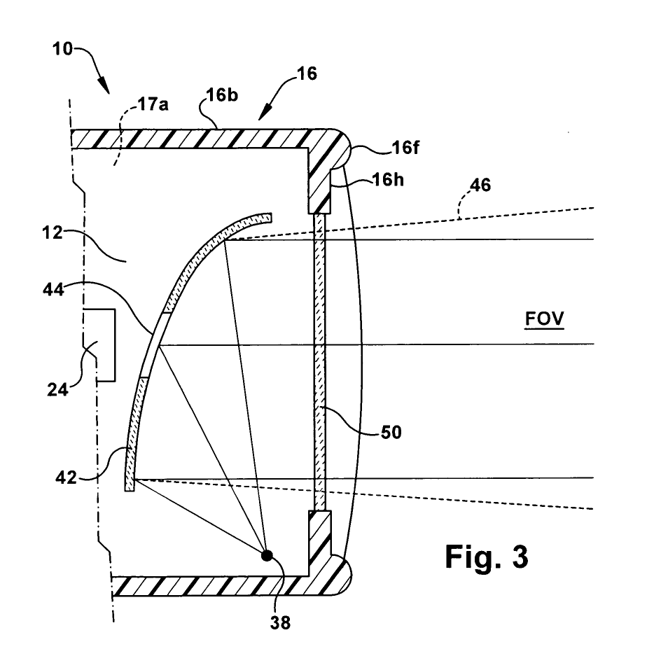

FIG. 3 illustrates in greater detail the arrangement of the curved mirror 42 and the LED 38 for shining light onto the mirror. While the schematic representation of the illumination assembly 36 shown in FIG. 3 includes a single LED 38, it should be recognized that a plurality of LEDs may advantageously provide for more uniform illumination of the target bar code 34 thereby avoiding hot spots in the target object (bright spot in local areas of the image) that might result from a single or multiple LEDs and, thus, enhancing decodability. Further, a plurality of LEDs may provide for greater illumination intensity on the target bar code 34 which under poor ambient lighting conditions, may also enhance decodability.

In the exemplary embodiment this mirror 42 approximates a parabolic surface. In the illustrated embodiment the light source 38 is positioned approximately at a focal point of the parabolic mirror so that the light bouncing off the mirror will follow generally collimated rays or beam paths approximately parallel to each other that neither diverge or converge. Parabolic mirrors are commercially available from Toyotec co. Ltd (www.toyotec.com/index-english.htm) having a place of business at Toyokawa Aichi, Japan. Usually parabolic mirrors are molded out of plastic material and then got coated with a proper reflective material such as gold, aluminum, or enhanced aluminum. The light reflected from the mirror illuminates a barcode 34. In an alternate embodiment, the location of the LED light source is optimized in such a way to have the light partially diverging along rays 46 for example in FIG. 1 so that illumination region at the imaging range of the scanner matches the field of view FOV of the imaging system. This adjustment of FOV is achieved by repositioning the light source 38 with respect to the mirror 42. In the disclosed embodiment in order to make the rays 46 slightly diverging, the source is moved within the handheld scanner slightly toward the mirror along a path leading to the mirror. The amount to move the source is dependent on the curvature of the mirror and the amount of divergence that is desired.

In the disclosed embodiment, the illuminating mirror 42 has a hole or gap 44 behind which the imaging systems camera housing 24 is positioned. The illustrated gap is generally circular in plan whose diameter is adjusted to meet the needs of the camera. The shape and the size of the gap can be optimized in such away so that not to truncate (interfere with) the FOV of the imaging camera. In the illustrated embodiment this is accomplished by coating a mirror substrate having the appropriate shape i.e. parabolic with a highly reflective coating where reflection is desired and leaving the substrate uncoated in the region of the gap 44 to allow light reflecting from the bar code to pass through the transparent substrate to which the mirror coating is not applied. The region of the gap 44 without the reflective coating may be generally flat to minimize potential distortion from a parabolic transparent surface. The gap 44 allows the imaging system to collect the light reflected back from the barcode 34 and process the image to read the barcode content. In an alternate embodiment, the camera is located above or below the mirror inside the housing. The surface of the mirror may be coated with a partially diffusive coating such as silver paint (usually gold or aluminum is used) by these means creating partially diverging light rays which improve the uniformity of illumination.

While a preferred embodiment of the invention has been described with a degree of particularity, it is the intent that the invention include all modifications and alterations from the disclosed design falling within the spirit or scope of the appended claims.

1. A bar code scanner comprising:
a scanner housing having a housing interior;
image capturing system within said housing interior for capturing a bar code image; and
an illumination assembly for emitting illumination light from the housing interior to a bar code target object spaced from the housing comprising:
i) an illumination source energizable to emit light to pass through a region of the scanner housing;
ii) a light transmitting window and
ii) a parabolic mirror having a concave surface which extends across a width of said light transmitting window positioned within the housing to reflect light from the illumination source through the light transmitting window to a region of interest outside the scanner housing;
wherein said illumination source is located at or near a focal point of the parabolic mirror to collimate light reflecting from the mirror.

2. (canceled)

3. The bar code scanner of claim 1 wherein the scanner housing includes a handle to allow the scanner to be manually moved about by a user, the light is visible light visible to the user after it exits the housing to allow user adjustment of the region of interest viewed by said scanner.

4. (canceled)

5. The bar code scanner of claim 1 wherein the mirror has a reflective coating on the concave surface for reflecting light

6. The bar code scanner of claim 5 wherein the mirror comprises a transparent substrate and the reflective coating surrounds a gap in the coating to allow light to pass through the substrate to reach the image capturing system.

7. The bar code scanner of claim 5 wherein the mirror comprises a substrate having a reflective coating, and wherein the substrate has a gap passing through the substrate to allow reflected light from the bar code to reach the image capturing system.

8. The bar code scanner of claim 1 wherein the illumination source comprises one or more light emitting diodes.

9. (canceled)

10. The bar code scanner of claim 1 wherein the illumination source is displaced slightly from the focal point to control the collimation of light reflecting from the mirror.

11. The bar code scanner of claim 10 wherein the displacement of the illumination source provides slightly diverging light in the region of interest.

12. A method of scanning a bar code at a region of interest comprising:
mounting an image analysis circuitry within a scanner housing for capturing a bar code image;
positioning a parabolic mirror having a concave surface that approximates a parabola within the scanner housing to reflect light from one or more light emitting diodes also positioned within the housing to a region of interest outside the scanner housing; wherein the one or more light emitting diodes are positioned within the scanner housing at or near a focal point of the concave surface that approximates a parabola to control collimation of light reflected by the parabolic mirror into the region of interest; and
selectively activating the one or more light emitting diodes to emit light to pass through a region of the scanner housing, bounce off the parabolic mirror, and illuminate the region of interest with controlled collimation outside the scanner housing.

13. The method of claim 12 additionally comprising interposing a light transmitting window between the mirror and the region of interest.

14. The method of claim 12 wherein the scanner housing is handheld, the illumination source emits visible light, and additionally comprising manually moving the scanner housing to aim the region of interest at a bar code when the illumination source is activated.

15. (canceled)

16. The method of claim 12 wherein a reflective coating is applied onto a curved substrate to create a reflective surface of the mirror.

17. The method of claim 12 wherein the mirror has a transparent substrate and the reflective coating surrounds a gap in the coating to allow light to pass reflected back from the region of interest to pass through the substrate to be gathered by an image capture device mounted within the scanner housing.

18. (canceled)

19. The method 12 wherein the illumination source is displaced slightly from said focal point of the parabolic mirror to control the collimation of light reflecting from the mirror.

20. The method of claim 19 wherein the displacement of the illumination source provides slightly diverging light in the region of interest.

21. A bar code scanner comprising:
a scanner housing having a housing interior;
image analysis means within said housing interior for capturing a bar code image; and
illumination means for emitting illumination light from the housing interior to a bar code target object spaced from the housing comprising:
i) source means comprising one or more light emitting diodes for emitting light to pass through a region of the scanner housing; and
ii) reflection means comprising a parabolic mirror positioned within the housing for intercepting and reflecting light from the source means to a region of interest outside the scanner housing;
said light emitting diodes located at or near a focal point of the parabolic mirror to control collimation of light reflecting from the mirror.

22. (canceled)

23. The bar code scanner of claim 21 additionally comprising positioning means for allowing the scanner to be manually moved about to adjust the region of interest viewed by said bar code scanner.

24. The bar code scanner of claim 21 reflecting means has a reflective coating on the concave surface for reflecting light.

25. The bar code scanner of claim 24 wherein the reflecting means has a transparent substrate and the reflective coating surrounds a gap in the coating to allow light to pass through the substrate.

26. (canceled)
